(19) United States
(12) Patent Application Publication
(10) Pub. No.: US 2025/0292752 A1
(43) Pub. Date: Sep. 18, 2025

(54) Air Horn with Extended Pressure Chamber

(71) Applicant: Jeremy Henderson, Merced, CA (US)

(72) Inventor: Jeremy Henderson, Merced, CA (US)

(21) Appl. No.: 18/607,950

(22) Filed: Mar. 18, 2024

(51) Int. Cl. G10K 9/04

(52) U.S. Cl. CPC G10K 9/04

(57) ABSTRACT

The present invention generally concerns an adjustable pneumatic device that creates sound. More specifically, the present invention improves diaphragm-based air horns by having a unique base with an extended pressure chamber, an adjustable volume lever, a tunable shaft that generates specific tonal pitches, and an optional sound amplification plate. The horn includes: an inverted closet flange, an annulus pressure plate, a pressure relief tube, a bushing connector, a collar coupling, an air inlet system, a flexible diaphragm, a resonator, rivets, screws, an optional sound amplification plate, and an air pump. Within the pressure chamber, a tube presses against a diaphragm via tension, causing the diaphragm to stretch beyond the lower portions of the base's bottom most surface. Compressed air traverses chamber spaces around the tube and about the extended pressure chamber to trigger diaphragm vibrations that generate sound at the resonator from 109 decibels to 129 decibels.

### RELATED APPLICATIONS

This non-provisional patent application does not claim priority to any other patent application.

### FIELD OF THE INVENTION

The present invention generally concerns an adjustable pneumatic device that creates sound. More specifically, the present invention improves diaphragm-based air horns by having a unique base with an extended pressure chamber, an adjustable volume lever, a tunable shaft that generates specific tonal pitches, and an optional sound amplification plate. The horn includes: an inverted closet flange, an annulus pressure plate, a pressure relief tube, a bushing connector, a collar coupling, an air inlet system, a flexible diaphragm, a resonator, rivets, screws, an optional sound amplification plate, and an air pump. Within the pressure chamber, a tube presses against a diaphragm via tension, causing the diaphragm to stretch beyond the lower portions of the base's bottom most surface. Compressed air traverses chamber spaces around the tube and about the extended pressure chamber to trigger diaphragm vibrations that generate sound at the resonator from 109 decibels to 129 decibels.

### BACKGROUND OF THE INVENTION

America loves football. Fans are constantly looking for new ways to show love for their favorite team and to be a part of the festivities that surround each game. They often dress in their favorite team colors, jerseys, hats, and other paraphernalia. The most loyal fans even try to replicate certain experiences solely unique to a specific football stadium. As a fan of the San Francico 49ers, I wanted to replicate the famous 49er's foghorn. The 49ers have a tradition of engaging a loud foghorn whenever the team scores a touchdown. In the Bay area, the San Francisco Giants baseball team was the first sports team to use such a horn within their stadium to engage with the fans when the ball team was winning.

The 49er's foghorn is similar to a Kahlenberg Model KM-135, which has a three-piece stainless-steel diaphragm and is made for boats at or above 200-meters. The Model KM-135 air horn can sound at 130 decibels for 22 continuous seconds. The present invention is my attempt to replicate the loudness and tone of a Kahlenberg air horn with common everyday parts that one would not consider when making the same.

Foghorns, or air horns, are mechanical devices that produce loud and startling sounds as a safety measure to locate the unseen on open seas. The horn's initial sound, or returning echo, signals nearby land masses or aid in avoiding one vessel from sailing into another. Today, air horns are heard on fire trucks to warn both civilians in their cars and walking the streets to be careful as firefighters respond to emergencies. Other uses for air horns include: auditory triggers for anxiety experiments, personal safety devices, as a warning for hazardous or harmful conditions at construction sites, and, of course, at sporting events.

When making the present invention, we researched the historical construction of air horns, and an air horn's method for producing sound is one of constant innovation. 1853, Robert Foulis created a steam powered horn, where hot steam was forced through a long cylindrical pipe to create a low monotoned sound on Partridge Island off the coast of New Brunswick, Canada. 1897, Robert Hope-Jones created the diaphone, where an air current moved a piston back and forth to open and close ports and to disrupt puffs of air that moved through the ports to create sound. 1905, John Astrom files, what seems to be, the first patent application related to a horn having an enclosed pressure chamber that uses a vibrating membrane to create sound.

The present invention is a membrane-based air horn. Not to be bound by theory, but membrane-based air horns are pneumatics that work on the simple principles of flowing air through an enclosed pressure chamber having interstitial spaces, a membrane or diaphragm secured at its ends, and an exit path. Air currents give mechanical energy to a membrane causing vibrations that produce pressure-based sound waves that rapidly exit through the distal end of a tube. Over the centuries, there have been many mechanical configurations for membrane-based horns.

U.S. Pat. No. 870,074 issued to John Astrom on Nov. 5, 1907 and concerns an apparatus for the production of vibrations. Astrom discloses a now classic air horn. There are two concentrically aligned vessels connected together at a base. There is an inlet valve to introduce compressed air within spaces about the concentrically aligned vessels. A diaphragm made from an elastic material is held taught against the upper portions of the first vessel by a countersunk cap. There is an outlet pipe just above an inner chamber. When compressed air is allowed into the inner spaces, the membrane vibrates, allowing air to build up in the inner chamber and escape through the outlet pipe thereby creating sound.

U.S. Pat. No. 1,335,921 to H.S.A. Rydberg issued on Apr. 6, 1920 and concerns a diaphragm sounder (the '921 patent). Rydberg discloses a membrane encased in an annular frame. The membrane is fastened into a sleeve and held by flanges. The frame includes an annular chamber capable of holding an inlet pipe for a fluid, which passes through the chamber causing the membrane to vibrate. A clamping ring secures the membrane to the flanges.

U.S. Pat. No. 1,655,675 to Allan Cunningham issued on Jan. 10, 1928 and concerns a diaphragm horn (the '675 patent). The Cunningham air horn is similar to Astrom's patented air horn but is singly casted horn having a diaphragm and a retaining nut or ring. The casting has a pressure relief tube that extends through a main pressure chamber. A diaphragm is positioned between the open ends of the pressure relief tube and the chamber. There is a fluid inlet portal. Air entering the portal passes between the chamber and the end of the pressure relief tube, which allows for pressure to build up and escape causing the diaphragm to vibrate. The diaphragm is 4″ thick and is held about the inner periphery of the casing by a clamping ring. The diaphragm is under no appreciable tension but is only held by the clamping ring. The pressure relief tube is connected to a horn, being one piece, that allows for the projection of sound when pressure escapes from the chamber via the release thereof. The '675 patent discloses that for a more efficient horn the distance across the end of the pressure relief tube and the width of the chamber is a whole multiple of the other.

U.S. Pat. No. 2,918,895 issued on Dec. 29, 1959 to R. D. Buell and concerns a horn that is fluid powered (the '895 patent). Buell discloses an air horn made from plastics having a housing, a tubular body having an outer end that is flared, wherein both are supported on a surface that is orthogonal to the enclosed chamber. The housing includes a base that has a series of mounting surfaces, an air flow chamber, a seat for one end of a tubular body for the directional flow of sound, a metal diaphragm, a paper gasket, an adjustable screw that places pressure on a seating cup, and an inlet at the base to connect a pressurized fluid source. The metal diaphragm beings to vibrate when pressurized air is allowed to flow through the inlet and about the air chamber that surrounds the seat. Air then flows between the diaphragm and the seat and out through the tubular horn. The pitch of the horn and the vibration amount of the diaphragm can be adjusted by a screw that is in contact with the bottom portion of the seat and cup. The air horn of the '895 patent is mounted to a surface by a boss and a screw. The Buell horn's volume cannot be significantly adjusted or amplified in real time.

U.S. Pat. No. 5,662,064 issued on Sep. 2, 1997 to Laszlo Gyorgy and concerns a high acoustic output horn being a tube within a tube design (the '064 patent). One tube is a pressure tube, and the other tube is a sound tube. They are coaxially joined, having a membrane that spans across the ends directed for sound generation. The '064 patent is a small handheld device operated by a user blowing into a port located on the outer surface of a pressure tube. The horn is small with a length of about 3″ inches and can be extended to about 9″ with additional tubes. The '064 patent focuses on the importance of a setback between the coaxial tubes at the sound generating end that contours the membrane, but it is flushed flat between the two. Also note that, a human body is capable of producing at most 2 psi of air, and Gyorgy reports that blowing into this small horn produces 100 decibels of sound. These sound levels do not seem possible from a human body without an external air pump.

U.S. Pat. No. 5,460,116 issued on Oct. 24, 1995 to Laszlo Gyorgy and concerns a horn for sports fans (the '116 patent). This patent is related to the '064 patent from the same inventor, Gyorgy. This horn is another tube within a tube design having a membrane stretched across the distal ends of the two tubes. The '116 patent discloses the horn as having a pressure tube, a sound tube, a membrane, a locking collar, and a retainer ring. The pressure tube is provided with a sound hole. The horn is 4″ long and about 2″ round. The membrane is a polyethylene foil being 0.002″ thick. Sound is generated by the same principle as the '064 patent. One blows air into the sound hole and into the interstitial spaces of the horn, thereby vibrating the membrane to create sound waves that exit at an opposite end. Like the '064 patent, extension tubes can be added to change the frequency of the emitted sound.

International Patent Publication Number WO2013/057528 was published on Apr. 25, 2013 by Laszlo Gyorgy and concerns an advertising horn. Although a different shape, this sound horn is the same as the horns disclosed in both the '064 patent and the '116 patent. There is a tube within a tube design. A pressure tube is coaxial with a sound tube. The pressure tube has a sound hole to which one can blow air. The horn is handheld and has a pressure medium feed pipe, a sound pipe, a membrane, and a fastening ring. One blows air into the spaces of the handheld horn, and the membrane vibrates to create sound.

U.S. Pat. No. 3,319,268 to J. J. Blumkranz issued on May 16, 1967 and concerns a water closet coupling (the '268 patent). Blumkranz discloses a spigot flange used to connect floor toilets to a waste drainage system. The spigot flange includes an annular plastic connector and an annular metal ring that are rotatably connected to each other. The plastic connector is made from acrylonitrile butadiene (ABS) or from another thermoset plastic. The connector has flanged edges that extend outwardly and are in contact with a projection that extends axially downward to form an annular groove about its outer surface. The connector also has a cylindrical outlet end that is internally threaded to fit with the threads of a drain waste conduit. The annular metal ring is formed with an upper wall and radially spaced apart inner and outer walls, which provide the ring with a U-shaped cross section. The metal ring is further defined by an annular lip that extends radially inward to its center. However, this lip has an inside diameter large enough as not to interfere with the previously mentioned flange. The metal ring's lip is a connection surface that allows the ring to be retained by friction within the connector at the toilet inlet end. The ring is provided with a series of counter sunk apertures that extend axially to receive screws. The purpose of the metal ring is to supply a sturdy interface between the toilet's outlet and the connector, wherein the connector's cylindrical outlet acts as a reducer to the drain waste conduit. Although the plastic connector is of a threaded type, U.S. Pat. No. 3,319,268 is herein incorporated by reference in its entirety.

U.S. RE47,752 reissued to the Oatey Co., of Cleveland, Ohio on Dec. 3, 2019 and discloses a closet flange system for an existing installation (the '752 reissue). The Oatey reissue gives a closet flange insert and spacer to attach to an existing closet flange. The insert is a through pipe having an annular flange at one of its distal ends that radially extends therefrom. The underside of the flanged portion has a downwardly extending wall that is annular and continuous, which is used to mate with an annular groove about a spacer. To reduce the diameter of the pipe at the outlet end, a tapered or flared section is located along the length of the through pipe. This tapered section can be thought of as a frustoconical intermediate portion having inner walls that are slightly sloped to reduce the diameter of the outlet end of said pipe. The outer diameter of the through pipe allows the insert to telescopically join with a pipe section of a previously installed closet flange. Both the insert closet flange and the previously installed closet flange have inlet openings that are of a similar size. The closet flange insert has a series of fastening holes circumferentially spaced apart and sized to accommodate typical screw sizes.

It takes considerable industrial know-how and resources to make any of the above air horns. We believe that the present invention is a first assembly for a pneumatic device that mimics industrial grade air horns in both tone and loudness that is made from plumbing accessories found at your local hardware store. With that, there is a need for the present invention.

### SUMMARY OF THE INVENTION

These and other advantages for creating an air horn with an extended pressure chamber are provided herein. One object of the present invention includes the air horn having: a resonator, a pressure relief tube, rivets, a bushing connector, a collar coupling, an inverted closet flange, a flexible diaphragm, an annulus pressure plate, an air inlet system, an optional sound amplification plate, and fasteners.

It is an object of the present invention for the air horn with an extended pressure chamber to have a pressure relief tube being a hollow cylindrical pipe made from acrylonitrile butadiene styrene (ABS) and is at least 2⅜″ in outer diameter and 2 feet in length.

It is an object of the present invention for the air horn with an extended pressure chamber to include a closet flange having an opening being a 4″ circular inlet that is connected to a through pipe of slightly smaller or of equal dimensions, wherein the circular inlet is connected to a metal ring, and wherein the closet flange is used in an inverted fashion as an integral part of an airtight system.

It is an object of the present invention for the air horn with an extended pressure chamber to have an airtight system that includes an inverted closet flange, a flexible diaphragm, and an annulus pressure plate, and wherein fasteners are used to tightly compress and secure all elements of the airtight system to ensure an effective airtight seal.

It is an object of the present invention for the air horn with an extended pressure chamber to include a pressure relief tube that telescopes into the through pipe of the inverted closet flange and presses downward onto the flexible diaphragm thereby extending said diaphragm beyond an enclosed pressure chamber by at least a ¼″ into and past a center ring of the annulus pressure plate.

It is an object of the present invention for the air horn with an extended pressure chamber to have a resonator being an 18″ safety cone having a vertex that is cut and modified to friction fit below the upper distal end of the pressure relief tube and secured thereon by rivets, and wherein the cone's base is aligned to act as a resonator having a decorative trim about the cone's annular edge.

It is an object of the present invention for the air horn with an extended pressure chamber where both the bushing connector and the collar coupling are ABS hubs typically used in plumbing, wherein the bushing connector is either a flanged or an un-flanged 4″—(spigot)×2″—(reducer hub) and the collar coupling is a 4″ hub×hub coupling.

It is an object of the present invention for the air horn with an extended pressure chamber to include a flexible diaphragm made from materials including: natural rubber, polychloroprene (neoprene), polyisoprene, styrene-butadiene rubber, ethylene elastomers, nitrile elastomers, polyurethane elastomers, ethylene propylene diene elastomer (EPDM), ethylene propylene elastomer (EPM), ethylene octene elastomers (EOM), ethylene butene elastomer (EBM), or any combinations thereof.

It is an object of the present invention for the air horn with an extended pressure chamber to have a flexible diaphragm made from an ⅛″ thick 7¼″×7¼″ square piece of polychloroprene (neoprene) that is eventually cut into a continuous annular shape having circumferentially placed holes that accept fasteners and wherein the outer diameter of the continuous annular shape is approximately 7″ to mimic the outer diameter of the inverted closet flange's metal ring.

It is an object of the present invention for the air horn with an extended pressure chamber to include an annulus pressure plate made from a ¼″ thick sheet of acrylic and is fashioned into an annular shape with an outer diameter of 7″ having holes cut circumferentially thereon, and wherein the annulus pressure plate has a center ring that is 4″ in diameter to mimic the inlet opening diameter of the inverted closet flange.

It is an object of the present invention for the air horn with an extended pressure chamber to have an air inlet system that includes a ball valve and handle, an air coupler, a threaded male connector, and an air hole drilled into both the walls of the collar coupling and the through pipe of an inverted closet flange.

It is an object of the present invention for the air horn with an extended pressure chamber to include an air inlet system that is directly connected to a compressed air pump by a hose to allow air flow into said horn, wherein the compressed air pump is capable of storing one gallon to one hundred gallons of compressed air.

It is an object of the present invention for the air horn with an extended pressure chamber to have an air inlet system that can vary the loudness of said horn from 109 decibels to 129 decibels by adjusting the air flow from the compressed air pump with the ball valve and handle.

It is an object of the present invention for the air horn with an extended pressure chamber to include adjusting the height of the pressure relief tube to cause tonal changes in the pitch of the horn.

It is an object of the present invention for the air horn with an extended pressure chamber to include an optional sound amplification plate that is made from a ¼″ thick piece of annular material being either acrylic, aluminum, or steel, and, wherein the optional sound amplification plate is cut and sized to be 7″ in diameter having circumferential holes to accept fastening members to attach said optional sound amplification plate to the air horn's base at the annulus pressure plate, such that the at least ¼″ protruding surface of the extended diaphragm is covered.

It is an object of the present invention wherein the air horn with an extended pressure chamber includes the optional sound amplification plate being made from a ¼″ thick piece of annular material being either acrylic, aluminum, or steel, and, wherein the optional sound amplification plate is cut and sized to be 7″ in diameter and is not attached to the air horn's base at the annulus pressure plate but the optional sound amplification plate is placed on a flat surface for the horn's base to rest, such that the at least ¼″ protruding surface of the extended diaphragm is covered.

### BRIEF DESCRIPTION OF THE DRAWINGS

The figures below are non-limiting examples of the present invention, and they are intended to capture, or contemplate, common changes to the same.

FIG. 1 is a lengthwise depiction of the air horn 10 including: resonator trim 1, a resonator 2, rivets 3, a pressure relief tube 4, a bushing connector 5, a ball valve with handle 6, a threaded connector (not shown), a collar coupling 7, an inverted closet flange 8 tightened down with screws, washers (not shown), and nuts 12, a flexible diaphragm 9, an annulus pressure plate 11, and an extended pressure chamber (not shown).

FIG. 2 depicts a lengthwise view of the air horn 10a connected to an air pump 13. The air horn 10a has an air inlet system 6a including a ball valve with handle being connected to the air pump 13 via connection threads 14a and a hose 14.

FIG. 3 is a lengthwise depiction of an air horn with an extended pressure chamber. This image includes: resonator trim 1b, a resonator 2b, a rivet 3b, a pressure relief tube 4b, a bushing connector 5b, a collar coupling 7b, an inverted closet flange 8b, a flexible diaphragm 9bi to make an extended pressure chamber 9bii, an annular pressure plate 10b, securing screws, washers (not shown), and nuts 11b, an air inlet system 6b, and a threaded connector (not shown).

FIG. 4 depicts a lengthwise view of the air horn with an extended pressure chamber including: resonator trim 1c, a resonator 2c, a rivet 3c, a pressure relief tube 4c, a bushing connector 5c, a collar coupling 7c, an inverted closet flange 8c, a flexible diaphragm 9ci to make an extend pressure chamber 9cii, an annulus pressure plate 10c, an air inlet system 6c, a threaded connector (not shown), securing screws, washers (not shown), and nuts 11c, and an optional sound amplification plate 12c.

FIG. 5 depicts an exploded view of the air horn 10 with an extended pressure chamber. This exploded perspective includes: resonator trim 15, a resonator 16, multiple rivets 17, a pressure relief tube 18, a bushing connector 19, a collar coupling 20, an inverted closet flange with a through pipe 21a and a metal ring 21b, a flexible diaphragm 22, an annulus pressure plate 23, securing screws, washers, and nuts 24, and an air inlet system including an air coupler 25a, a ball valve and handle 25b, and a threaded coupler 25c. The optional sound amplification plate is not shown.

FIG. 6 depicts a cross section view of the extended pressure chamber. The image shows the pressure relief tube 26 being held by a flanged bushing connector 27 that mates with a collar coupling 28. The pressure relief tube 26 telescopes into the outlet and inlet portions of a through pipe 30 for an inverted closet flange having a metal ring 31. The pressure relief tube 26 applies tension across the surface of a flexible diaphragm 38b while the edges of the diaphragm 38a are secured and fixed at its edges by the airtight system. This tension pushes the diaphragm 38b beyond the confines of the enclosed pressure chamber 29 and extends it past the bottom most surfaces of the air horn's base. The differing sizes between the inlet diameter of the through pipe 30 and metal ring 31 of the inverted closet flange and the diameter of the pressure relief tube 26 create chamber spaces 29 for pressure build up. An annulus pressure plate 32 and fasteners 39 are used to tighten the assembly to form an airtight seal amongst said plate 32, the diaphragm 38a, 38b and the inverted closet flange 30, 31. An air inlet system includes: an air hole 35 drilled into the sides of both the collar coupling 28 and the through pipe 30 of the inverted closet flange, a threaded male connector 34, a ball valve 37 and handle 33, and a threaded air couple 36.

FIG. 7 depicts a profile of the air horn's extended pressure chamber with optional amplification plate. This view shows the pressure relief tube 40 being held by a bushing connector 41 that is mated with a collar coupling 42. An air hole 43 is drilled into both the side of the collar coupling 42 and the through pipe 45 of the inverted closet flange. The relief tube 40 applies tension across the center portion of a flexible diaphragm 46b. This tension stretches the diaphragm 46b beyond the confines of the enclosed pressure chamber and extends it past the bottom most surfaces of the air horn's base, wherein an optional sound amplification plate 49 can be installed. Fasteners 48a, 48b are used to tighten the assembly to create an airtight seal amongst the sound amplification plate 49, the annular pressure plate 47, the diaphragm 46a, 46b, and the inverted closet flange 44, 45.

FIG. 8 depicts an exploded view of the pressure chamber's bottom elements configured to form an airtight seal, being: an inverted closet flange 50 having a through pipe 50b, an air hole 50e, an inverted inlet opening 50a, a metal ring 50c, and screw holes 50d. Also depicted is a flexible diaphragm 51 having screw holes 51a, and an annular pressure plate 52 with screw holes 52b and a center ring 52c.

FIG. 9 depicts an underneath and angled view of a partially deconstructed pressure chamber. The pressure relief tube 53 passes through a bushing connector 54 that is telescopically mated with a collar coupling 55. The pressure chamber is a space between the inlet opening 60 and the side walls of the through pipe 56 of the inverted closet flange. This space is partly defined by a frusto conical intermediate surface extending from the inlet opening 60. A pump (not shown) directs air through the air inlet system and into that space, wherein the underside of the ball valve and handle 59 and an air hole 58 bored into the side walls of both the collar coupling 55 and the through pipe 56 are shown. When the horn is sealed airtight with an annular pressure plate (not shown), a diaphragm (not shown), and the metal ring 57 of the inverted closet flange, the air pressure at the bottom portion of the horn increases. Note that, the relief tube 53 will be positioned to contact and apply tension to the diaphragm (not shown) to extend the flexible material beyond the base's bottom most surfaces, thereby creating an extended pressure chamber. The increased air pressure surrounding the distal end of the pressure relief tube 53 will cause the diaphragm to vibrate.

### DETAILED DESCRIPTION OF THE INVENTION

From this point forward, the following words describe an improved air horn having a unique base with an extended pressure chamber, an adjustable volume lever, a tunable shaft that generates specific tonal pitches, and an optional sound amplification plate. However, these words are not a limitation on the scope of the present invention but are shared to illustrate certain embodiments thereof. The improved air horn can be better detailed using the following non-limiting words.

### Definitions

The word “tunable” generally refers to the ability of the air horn to be adjusted in both pitch and volume. The horn can emit different pitches when the pressure relief tube is moved up and down axially relative to the pressure chamber. Also, the horn's volume can be increased or decreased by controlling the amount of compressed air allowed into the pressure chamber by the air inlet system.

The words “air inlet system” generally refers to the aggregation of a ball valve and handle, an air coupler, a threaded male connector, and an air hole drilled into both the walls of the collar coupling and the through pipe of an inverted closet flange. A hose connects an air pump to the air coupler to supply air to the air horn's extended pressure chamber when the ball valve is opened by the handle.

The word “pneumatic” generally refers to a thing that is related to or operated by air.

The words “inverted closet flange” generally refer to a closet flange, or toilet flange, typically used in plumbing to connect a toilet outlet to the inlet of a waste conduit. Here, the closet flange is used in an inverted fashion as an integral part of an airtight system. Closet flanges are typically defined by an annular inlet portion, a through pipe to connect to a waste conduit, and a metal ring that flanges outward from the outer diameter of the inlet portion. The inverted closet flange is a one-piece assembly that includes a first cylindrical portion having an inlet designed to allow the flow of toilet water into a waste conduit and a second cylindrical portion being an outlet pipe (through pipe) designed to telescope said flange with a waste conduit. The third cylindrical portion is a metal ring that radially extends about the outer edges of the inlet to secure a toilet to a floor.

The words “air horn” or “horn” generally refers either to the invention in its complete assembly.

The word “resonator” generally refers to a cone attached to a pressure relief tube that acts as such to direct sound waves generated by escaping air from the extend portions of a vibrating flexible diaphragm.

The words “diaphragm” or “membrane” generally refers to a flexible piece of material capable of being stretched by a downward tube and can vibrate when exposed to an air current to generate waves that are converted to an audible tone.

The words “airtight system” generally refer to a connected assembly including: an inverted closet flange, a flexible diaphragm, an annulus pressure plate, and fasteners used to secure and isolate the bottom portions of the present invention from loss of air pressure due to leaks, wherein silicon sealants are also used to accomplish a tight seal.

The words “sound amplification plate” or “amplification plate” generally refer to a piece of material that is cut and sized to cover both the 7″ diameter of the annulus pressure plate and the protruding surface of the extended diaphragm. The amplification plate is solid only having circumferential holes to accept fastening members to attach it to the air horn's base. The amplification plate allows for the efficient collection of static sound waves that would be lost to ambient surroundings but for this surface. More soundwaves are allowed to build up and escape through the pressure relief tube thereby giving a louder sound from the resonator.

The words “pressure relief tube” generally refers to a cylindrical pipe that both serves as a path for standing vibrational waves to escape the expected pressure chamber and as a tool to apply force to stretch the flexible diaphragm beyond the confines of an enclosed pressure chamber.

The word “fasteners” generally refers to screws, washers, and nuts used to tighten and seal the air tight system, where the head of a screw contacts a washer and the screw's body is allowed to pass through the aligned holes for each element of the air tight system to then contact a nut to be tightened to apply pressure to the same.

The word “annulus” generally refers to a ring-shaped object being two concentric circles.

The words “pressure chamber” generally refer to an airtight space confined within a housing that includes the inner surfaces of an assembly being: a bushing connector, a collar coupling, an air inlet system, an inverted closet flange, a flexible diaphragm, and an annulus pressure plate. The construct is additionally reinforced with adhesives, screws, washers, and nuts. The inner spaces of the pressure chamber are partly defined by a frusto conical intermediate surface at the inlet opening of the inverted closet flange. The bottom portions of the pressure chamber are defined by the compressed and sealed interfaces of the inverted collar flange, the flexible diaphragm, and the annulus pressure plate. The enclosed chamber space is extended by a pressure relief tube positioned to contact and apply tension to the diaphragm, which stretches the flexible material beyond the base's bottom most surfaces, thereby creating an extended pressure chamber.

### Air Horn Assembly

This is a non-limiting instruction for making an air horn with an extended pressure chamber. The air horn is made from parts readily available at your local hardware store or on amazon.com. Although assembled from unconventional parts, the present invention can match the tone and loudness of industrial grade air horns. The present invention includes a unique base having an extended pressure chamber, an adjustable volume lever, a tunable shaft that generates specific tonal pitches, and an optional sound amplification plate, all of which improve upon the essence of diaphragm-based horns.

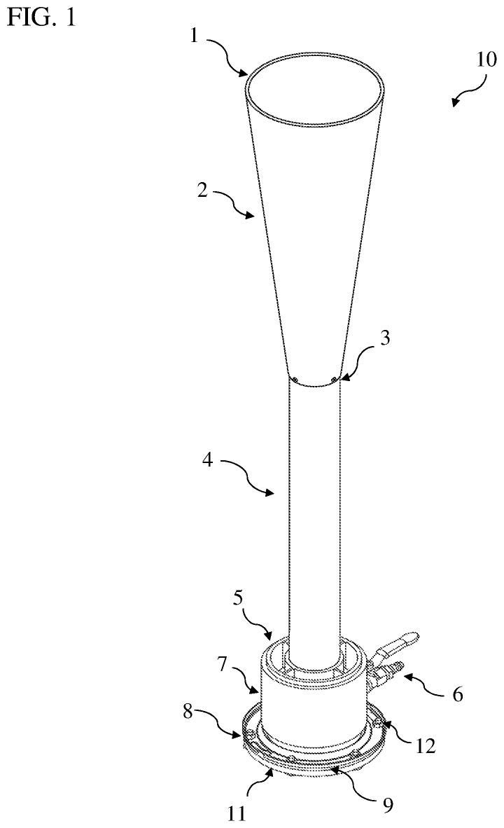

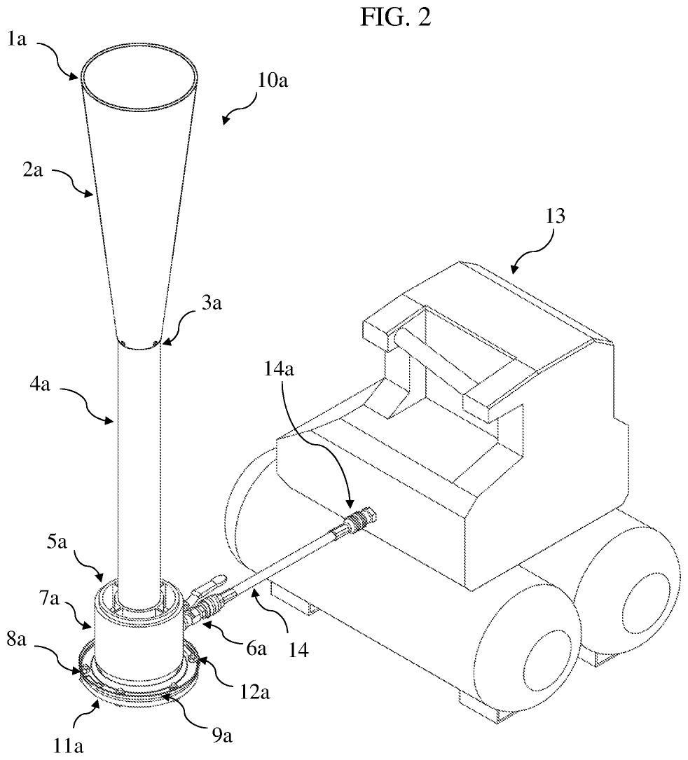

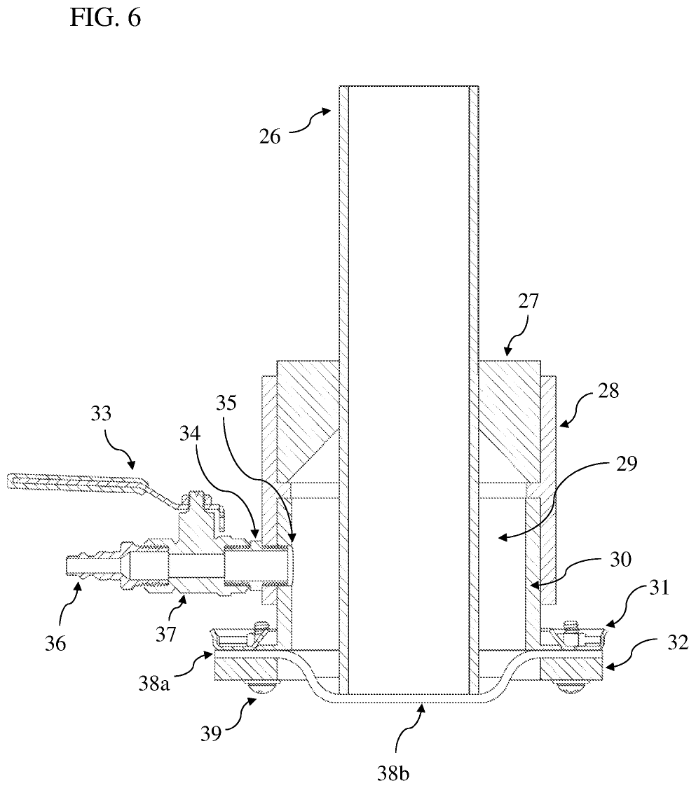

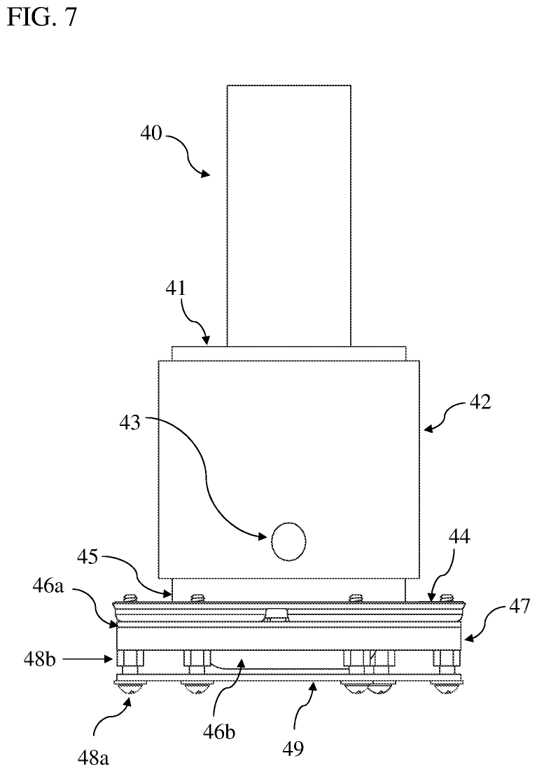

FIG. 1 is an axial perspective of the present invention. From top to bottom the invention includes: a resonator 2 with resonator trim 1, rivets 3, a pressure relief tube 4 acting as a sound shaft, a bushing connector 5, a collar coupling 7, an air inlet system 6, an inverted closet flange 8, a flexible diaphragm 9, an annulus pressure plate 11, screws, washers (not shown), and nuts 12, an optional sound amplification plate (see FIG. 4 or FIG. 7), and, lastly, an air pump (see FIG. 2). The pressure chamber is sealed airtight by screws, washers (not shown), and nuts 12 that are inserted through aligned holes in each of the inverted closet flange 8, the flexible diaphragm 9, and the annulus pressure plate 11. Each screw 12 is tightened with a nut at the metal ring of the inverted closet flange 8. The pressure relief tube 4 telescopes into both a 2⅜″ bushing 5 and the through pipe of the inverted closet flange 8. The tube 4 exerts a downward force onto the flexible diaphragm 9 to extend the material beyond the enclosure of the pressure chamber and into and past the center ring of an annulus pressure plate 11. An extended pressure chamber is defined by the pressure relief tube 4 pressing against the flexible diaphragm 9 such that the diaphragm 9 is stretched, extended, and pushed into ambient air at the horn's bottom most surface (see FIG. 6).

FIG. 2 depicts an air inlet system 6a that connects the horn 10a to an air pump 13. Connections include ⅜″ to ¼″ air fittings 14a and a hose 14. Compressed air creates a buildup of air pressure that traverses the inner spaces surrounding the pressure relief tube 4a. This triggers vibrations to the extended diaphragm 9a. These vibrations create sound waves that exit through a resonator 2a attached to the tube 4a. The escaping waves result in a sound ranging from 109 decibels to about 129 decibels. It is an embodiment of the present invention wherein the operating psi for the air horn 10a is 100 psi to 250 psi. The connection hose 14 can be a Flexzilla® brand air hose, being ⅜″×50 ft. in length with ¼″ MNPT fittings. Compressed air pumps are available from companies and brands such as: HF McGraw®, Hyper Tough™, Graco® Inc. [Husky], Milwaukee®, Lowe's Project Source™, Lowe's Kobalt™, Craftsman®, Dewalt®, Rigid®, or Makita®. So long as the compressor 13 can store one gallon to a hundred gallons of compressed air and produce at least 100 psi of pressurized air, then the present invention 10a will generate a sound comparable to industrial grade air horns.

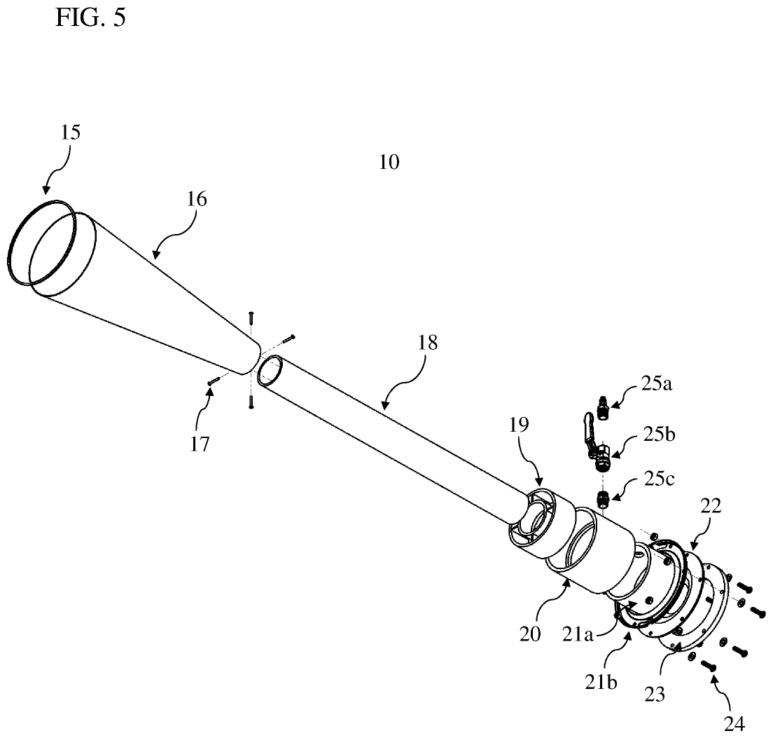

How do we assemble the horn? From the exploded view of FIG. 5, we first create a housing for the pressure chamber. We telescope, via friction fit, a 4″ (spigot)×2″ (reducing hub) ABS DWV bushing 19 into a 4″ ABS hub×hub coupling 20, wherein the coupling has an inner diameter of about 4½″ and an outer diameter of about 5⅙″. The bushing 19 can either be flanged or un-flanged and is routinely used in plumbing as a transition fitting/reducer and readily telescopes within the coupling. These ABS fittings are easily found at your local hardware store or can be bought online. It is a preferred embodiment of the present invention wherein both the bushing 19 and the coupling 20 are made from Acrylonitrile Butadiene Styrene (ABS) or from Polyvinyl chloride (PVC).

A fast set 4″ ABS open hub closet flange with a metal ring is mated to a distal end of the coupling 20. A closet flange secures and connects a toilet outlet to a waste conduit via a metal ring 21b and a through pipe (spigot) 21a respectively (see the '268 patent). However, the present invention 10 does not use the closet flange in its normal orientation. We invert it. The through pipe 21a now points straight up, and the metal ring 21b is in a downward position. This inversion allows the through pipe 21a to telescopically interface with both the coupling 20 and the pressure relief tube 18. The metal ring 21b serves as the top portion of the horn's 10 airtight system. The housing is reinforced by the application of an ABS medium drying cement. The adhesive is applied at points between the bushing 19 and the coupling 20 and at points between the coupling 20 and the through pipe 21a. The cement is allowed to cure for at least thirty minutes. After the cement hardens, a ⅝″ round air hole is drilled into both the outer bottom surface of the coupling 20 and into the side wall of the through pipe 21a. These holes (not shown) allow compressed air to be released into the extended pressure chamber.

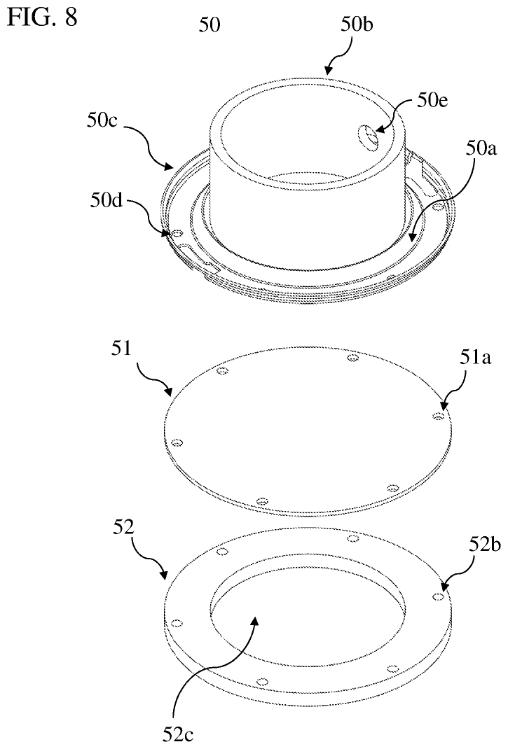

FIG. 8 shows the elements used to create an airtight system: an inverted closet flange 50, a flexible diaphragm 51, and an annulus pressure plate 52. We use a fast set 4″ ABS open hub closet flange 50 having a metal ring 50c, wherein the metal ring 50c has an outer diameter of 7″ and a series of holes 50d circumferentially distributed thereon to accept screws. This sort of flange is sold under the Oatey® brand of toilet flanges at Home Depot® or Lowes®. As mentioned above, the closet flange 50 is normally used to secure and connect a toilet's outlet to a waste conduit via a metal ring 50c and a through pipe (spigot) 50b. However, the present invention inverts the closet flange 50 from its normal orientation. The through pipe 50b now points straight up, and the metal ring 50c is downward.

Remaining with FIG. 8, the closet flange's 50 inlet opening 50a faces downward to interface with the diaphragm 51. The through pipe 50b is upwardly oriented to join with the coupling and to accept the later installed pressure relief tube (see FIG. 5). The side wall of the through pipe 50b has a ⅝″ round air hole 50e bored into it to accommodate one end of a ⅜″×⅜″ male-male threaded coupler, which is a part of the air inlet system and is the entry point for compressed air into the extend pressure chamber.

The flexible diaphragm 51 can be made from materials including but not limited to: natural rubber, polychloroprene (neoprene), polyisoprene, styrene-butadiene rubber, ethylene elastomers, nitrile elastomers, polyurethane elastomers, ethylene propylene diene elastomer (EPDM), ethylene propylene elastomer (EPM), ethylene octene elastomers (EOM), ethylene butene elastomer (EBM), and the like. It is an embodiment of the present invention wherein the diaphragm 51 is made from an ⅛″ thick 7¼″×7¼″ square sheet of polychloroprene (neoprene) that is eventually cut into a continuous annular shape mimicking the outer diameter of the closet flange's metal ring 50c, where the sized neoprene has an outer diameter of approximately 7″. Holes 51a are cut circumferentially about the flexible diaphragm 51 to align with the holes 50d available on the closet flange's 50 metal ring 50c to allow screws, washers, and nuts to connect the same.

An annulus pressure plate 52 is the last element of the airtight system, being made from a ¼″ thick sheet of acrylic. The pressure plate 52 is cut into an annulus shape mimicking the outer diameter of the closet flange's 50 metal ring 50c, being approximately 7″ round. The pressure plate 52 has a center ring 52c that is 4″ in diameter to mimic the inlet 50a diameter of the closet flange 50. Holes 52b are cut circumferentially about the pressure plate 52 to align with the holes 51a, 50d available on the closet flange's 50 metal ring 50c and the flexible diaphragm 51.

A silicon adhesive is then applied to the underside of the ABS inlet portion of the closet flange 50a, the flexible diaphragm 51, and the pressure plate 52. General Electric's® Advanced Silicone 2 Bath and Kitchen Sealant is a good silicone adhesive. Screws are inserted through the holes 52b, 51a, 50d and contacted with a washer and nut to tightly compress and secure all elements of the airtight system. All are locked down with enough pressure so as not to crack the annulus pressure plate 52 but to ensure an effective airtight seal. The silicon adhesive is allowed to cure from twelve to eighteen hours.

Returning to FIG. 5, it is an embodiment of the present invention wherein the pressure relief tube 18 is a cylindrical pipe made from ABS and is 2 ft in length with a 2⅜″ outer diameter. This pipe 18 can be purchased from Charlotte Pipe and Foundry Co. located in Charlotte, North Carolina. The pressure relief tube 18 telescopes through the reducer portion of the bushing 19, where the reducer's inner diameter is increased to just above 2⅜″ from its natural 2″ diameter by a hole saw drill bit and subsequent smoothing with a sixty grit sanding drum. Increasing the inner diameter of the bushing 19 by fractions of an amount above ⅜″ allows the pressure relief tube 18 to frictionally telescope within the inner portions of the bushing 19, where force will be used to knock the pipe 18 onto the diaphragm's 22 surface to extend the pressure chamber past the lower surfaces of the horn's 10 base (see FIG. 6).

Every air horn has a sweet spot: physical limitations by which one gets the most efficient diaphragm vibration, sound projection from the horn, and pitch. These limitations are based on the size and actual construction of the horn's pressure chamber, the location and size of the pressure relief tube relative to a fixed diaphragm, the type of diaphragm used, and the amount of pressure that the pressure chamber will allow.

The '675 patent discusses the importance of the distance between the diameter of the pressure relief tube and the end-to-end width of the pressure chamber. In order to get a clear and powerful tone, the '675 patent requires that these distances be a whole factor or at least be a multiple of each other. These distances allow the diaphragm to vibrate in a common plane creating static waves that build up and escape through the pressure relief tube.

In order to get a loud tone from a small handheld horn, the '064 patent discusses the importance of a distance referred to as a setback, which is best described as an offset space between the distal end surfaces of coaxial joined sound and pressure tubes. The setback is more or less an offset alignment between the coaxially joined tubes having an ideal space with an optimum distance by which a diaphragm is stretched to vibrate efficiently to produce a sound. The ideal setback is given in a bizarre unitless number to ensure the diaphragm is stretched between the end of the two tubes at a proper depth and distance.

As with these exemplary horns, we too have physical limitations, or a sweet spot, by which the present invention creates standing waves for sound. The sweet spot of the present invention is based on extending the pressure chamber. Of how the pressure chamber is extended, is shown in the cross section of FIG. 6, which includes: the pressure relief tube 26, the bushing 27, the coupling 28, the inverted closet flange having a thorough pipe 30 and a metal ring 31, a flexible diaphragm 38, the annulus pressure plate 32, screws, washers, and nuts 39, an air hole 35, a threaded male coupling 34, a handle 33 and ball valve 37, and an air coupler 36.

FIG. 6 clearly shows how the enclosed chamber space 29 is extended. The upper portion of the pressure relief tube 26 is hit with a mallet. The circumferential ends of the flexible diaphragm 38a are anchored by the airtight system to both ensure a true enclosure and to serve as a taught support when the center portion of the diaphragm 38b is extended into the lower portions of the base by the tube 26. A second annulus plate (not shown) is cut and sized identical to the now sealed pressure plate 32 and is used as a shim and to raise the horn another ¼″ above a flat surface. When the tube 26 is struck, the shim aligns and ensures that the diaphragm 38 does not extend more than ¼″ beyond the surface of the center ring of the annulus pressure plate 32. Within the pressure chamber 29, the tube's 26 distal end applies force, via friction and tension, to stretch the flexible diaphragm 38 away from the enclosed parts of the pressure chamber 29, thereby creating an extension thereof.

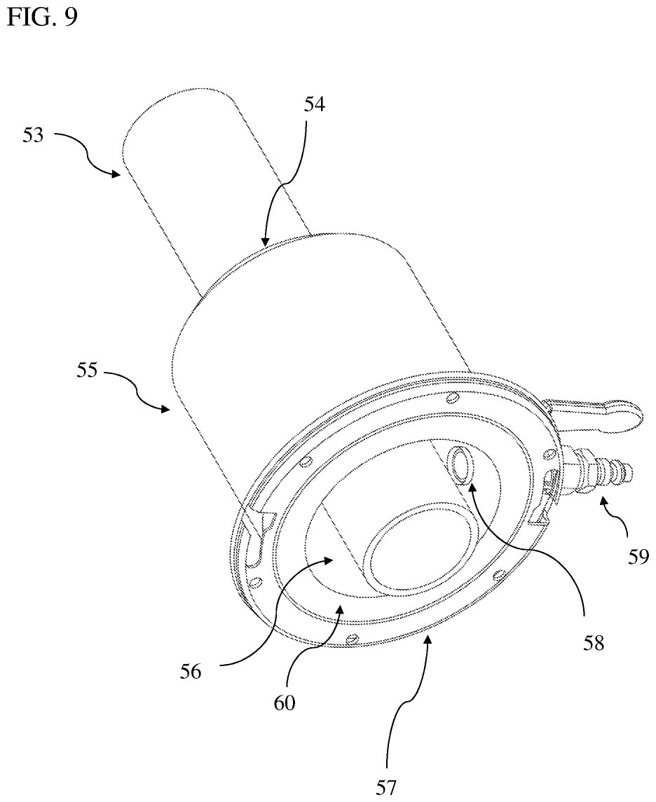

FIG. 9 and FIG. 6 are related in that, FIG. 9 depicts an underneath and angled view of a partially deconstructed pressure chamber. This is the area that is extended by the tube 53 and flexible diaphragm (not shown) as seen in FIG. 6's cross section. The pressure relief tube 53 passes through a bushing 54 that is telescopically mated with a collar coupling 55. The inlet opening 60 of an inverted closet flange provides a space 56, being further defined by the walls of a through pipe that surrounds a distal end of the tube 53. A pump (not shown) directs air through the air inlet system 59, which enters into that space 56 and increases air pressure at the airtight bottom portions of the horn. Note that, the relief tube 53 will be positioned to contact and apply tension to the diaphragm (not shown) to extend the flexible material beyond the base's bottom most surfaces, thereby creating an extended pressure chamber (see FIG. 6). Also shown is the underside of the ball valve and handle 59 and the air hole 58 that is bored into the side walls of both the collar coupling 55 and the through pipe 56 of the inverted closet flange.

We then attach a resonator to the upper portion of the invention. FIG. 5 shows an inverted cone being used as a resonator 16. An 18″ traffic cone is used. They can be bought on amazon.com. The base of the cone is removed with a cutting tool. From the cone's 16 vertex, we measure 3 7/16″ down and draw a cutting line. A tool is then used to remove the top portion thereof. An orbital sander smooths the cut edges. The cone 16 is inverted, and the cut smaller end is forced onto the top portion of the pressure relief tube 18 that is not concealed within the pressure chamber. The cone is situated ¾″ to ⅞″ from the top of the pressure relief tube 18 and then secured thereon with ⅛″ rivets 17 using a Milwaukee M12 Rivet Gun. The types of rivets can be Arrow brands ⅛″ by ¼″ Zinc Steel Blind Rivets, which are available at Lowe's®. The base of the cone 16 is now a proper resonator for the pressure relief tube 18. The outer circumferential edges of the resonator are then lined with cut strips of Cowles-Superior 18 ft Black U-Channel Edge Guard Trim 15.

Returning to FIG. 6, compressed air is supplied to the extended pressure chamber via an air inlet system that includes: an air inlet hole 35, a ⅜″ ball valve 37 and handle 33, a ¼″ to ⅜″ air coupler 36, a ⅜″×⅜″ threaded male coupling 34 made of zinc or brass, and a compressed air pump (not shown, but see FIG. 2). The ball valve 37 and handle 33 can be purchased from Harbor Freight at harborfrieight.com under the Merlin compressor shut off kit brand. The air coupler 36 is a Husky® brand ¼″ (IM) Plug-⅜″ NPT (M) type plug. Compressed air is allowed to flow through the chamber when the handle 33 opens the ball valve 37. Air that flows through the chamber 29 and its extension 38b imparts mechanical energy to the portion of the flexible diaphragm 38b that is under appreciable tension by the tube 26. As not to be bound by theory, we believe we have created a well that is conducive to the formation of standing pressure waves, and that these waves mostly propagate at the lower surfaces of the extended diaphragm 38b. At some point the waves travel up the relief tube 26 and through the resonator to create sound. It is a preferred embodiment of the present invention wherein the diaphragm protrudes ¼″ beyond the center ring of the annulus pressure plate 32, thereby extending the pressure chamber into ambient conditions.

Because the tube and the diaphragm extend the pressure chamber into ambient conditions, we observe that the horn loses vibrational energy to open air, thereby decreasing the horn's volume. We solve this issue by the addition of an optional sound amplification plate. FIG. 7 is an external view of the extended pressure chamber, which includes: the pressure relief tube 40, the bushing 41, the coupling 42 having an air hole 43, the through pipe 45 and metal ring 44 of the inverted closet flange, the flexible diaphragm 46a, 46b, the annulus pressure plate 47, fastening screws with washers 48a, nuts 48b, and a sound amplification plate 49. As mentioned above, some amount of vibrational energy from the extended diaphragm 46b is lost to ambient conditions. We discovered that placing a covering 49 near the surfaces of the extended portions of the diaphragm 46b allows that energy to be conserved, which reflects in a greater number of standing soundwaves available to create sound at the resonator.

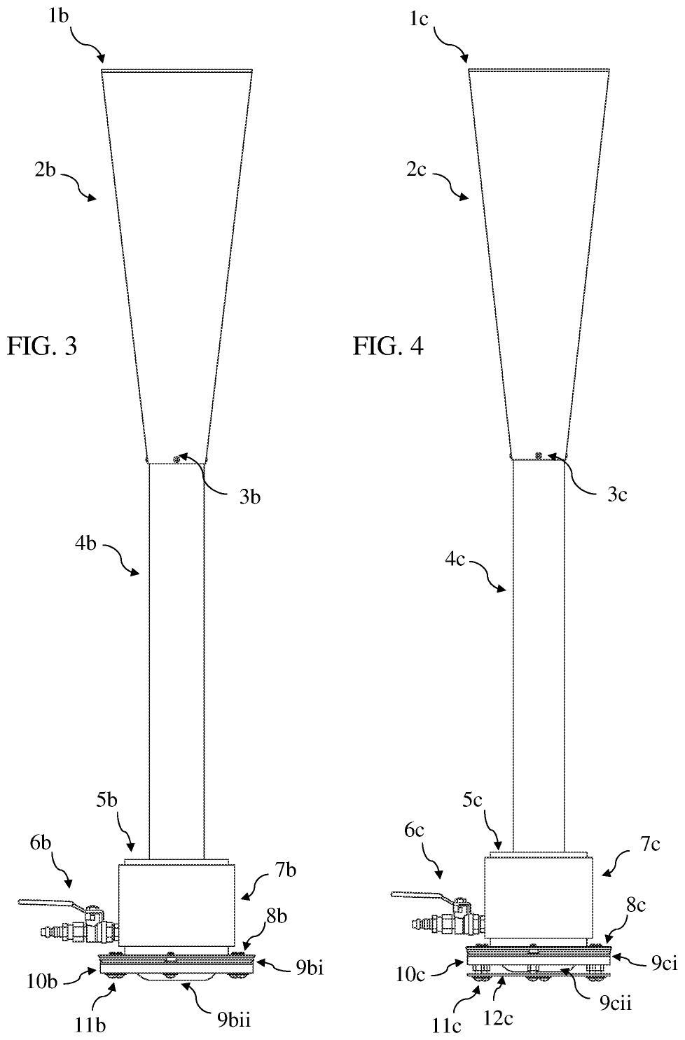

FIG. 3 and FIG. 4 are a side-by-side comparison of the invention without and with the sound amplification plate respectively. Both FIG. 3 and FIG. 4 include: a resonator 2b, 2c with resonator trim 1b, 1c, rivets 3b, 3c, a pressure relief tube 4b, 4c, a bushing 5b, 5c, a coupling 7b, 7c and air inlet system 6b, 6c, an inverted closet flange 8b, 8c, a flexible diaphragm 9bi, 9ci, an annulus pressure plate 10b, 10c, and screws, washers, and nuts 11b, 11c. FIG. 3 depicts an embodiment of the present invention wherein the diaphragm 9bi is secured on its side by the airtight system but is extended 9bii beyond the bottom most surfaces of the annulus pressure plate 10b by the downward pressing tube 4b. In this configuration, air that acts upon the extended pressure chamber causes the extended portion of the diaphragm 9bii to vibrate creating standing waves at the lower surfaces, where some of the vibrational energy is lost to ambient conditions. This causes the horn to lose volume.

FIG. 4 depicts the solution. We added an optional sound amplification plate 12c to conserve any vibrational energy that was previously lost to ambient conditions. Not to be bound by theory, but we believe that adding the amplification plate 12c acts as a reflective surface that captures and reinforces some of the standing sound waves generated at the extended diaphragm 9cii, thereby giving louder volumes. It is an embodiment of the present invention wherein the sound amplification plate is a solid round construct that is 7″ in diameter and a ¼″ thick made from either acrylic, aluminum, or steel.

It is an embodiment of the present invention wherein; the optional sound amplification plate is not attached to the bottom most portions of the horn, but it is placed on a flat surface to which the horn's base can rest to achieve the same sound amplification. Sitting the horn in an upright position on a surface having the sound amplification plate will give the desired effect of conserving vibrational energy at the extended diaphragm when it is vibrating. We also found that using different materials as a resting surface gives different tonal qualities at the resonator when the horn is active.

It is a further embodiment of the invention wherein the actual position of the handle connected to the ball valve regulates the decibel levels, or loudness, of the horn. This means that the horn's volume is tunable from about 109 decibels to about 129 decibels covering both configurations of the invention. It is also an embodiment of the present invention wherein the horn's pitch can be altered by either selecting and installing a longer pressure relief tube or by adjusting the height of the 2 ft tube upon installation.

We have described various exemplary aspects for improvements to an air horn. It is, of course, not possible to describe every conceivable combination of components or methodologies for purposes of describing these aspects, but one of ordinary skill in the art may recognize that many further combinations and alterations are possible. The invention is not limited to any particular dimensions of the various elements, but the above are non-limiting examples of a practical size. Accordingly, the aspects described herein are intended to embrace all such alterations, modifications, and variations that fall within the spirit and scope of the following claims.

We claim:

1. An air horn with an extended pressure chamber comprising: a resonator, a pressure relief tube, rivets, a bushing connector, a collar coupling, an inverted closet flange, a flexible diaphragm, an annulus pressure plate, an air inlet system, an optional sound amplification plate, and fasteners.

2. The air horn with an extended pressure chamber of claim 1, wherein the pressure relief tube is a hollow cylindrical pipe made from acrylonitrile butadiene styrene (ABS) and is at least 2⅜″ in outer diameter and 2 feet in length.

3. The air horn with an extended pressure chamber of claim 1, wherein the closet flange has an opening that includes a 4″ circular inlet being connected to a through pipe of slightly smaller or at equal dimensions, wherein the circular inlet is connected to a metal ring, and wherein the closet flange is used in an inverted fashion as an integral part of an airtight system.

4. The air horn with an extended pressure chamber of claim 3, wherein the airtight system includes an inverted closet flange, a flexible diaphragm, and an annulus pressure plate, and wherein fasteners are used to tightly compress and secure all elements of the airtight system to ensure an effective airtight seal.

5. The air horn with an extended pressure chamber of claim 3, wherein the pressure relief tube telescopes into the through pipe of the inverted closet flange and presses downward onto the flexible diaphragm thereby extending said diaphragm beyond an enclosed pressure chamber by at least a ¼″ into and past a center ring of the annulus pressure plate.

6. The air horn with an extended pressure chamber of claim 1, wherein the resonator is an 18″ safety cone having a vertex that is cut and modified to friction fit below the upper distal end of the pressure relief tube and secured thereon by the rivets, and wherein the cone's base is aligned to act as a resonator having a decorative trim about the cone's annular edge.

7. The air horn with an extended pressure chamber of claim 1, wherein both the bushing connector and the collar coupling are ABS hubs typically used in plumbing, wherein the bushing connector is either a flanged or an un-flanged 4″—spigot×2″—reducer hub and the collar coupling is a 4″ hub×hub coupling.

8. The air horn with an extended pressure chamber of claim 1, wherein the flexible diaphragm is made from materials including: natural rubber, polychloroprene (neoprene), polyisoprene, styrene-butadiene rubber, ethylene elastomers, nitrile elastomers, polyurethane elastomers, ethylene propylene diene elastomer (EPDM), ethylene propylene elastomer (EPM), ethylene octene elastomers (EOM), ethylene butene elastomer (EBM), or any combinations thereof.

9. The air horn with an extended pressure chamber of claim 1, wherein the flexible diaphragm is made from an ⅛″ thick 7¼″×7¼″ square piece of polychloroprene (neoprene) that is eventually cut into a continuous annular shape having circumferentially placed holes that accept fasteners and wherein the outer diameter of the continuous annular shape is approximately 7″ to mimic the outer diameter of the inverted closet flange's metal ring.

10. The air horn with an extended pressure chamber of claim 1, wherein the annulus pressure plate is made from a ¼″ thick sheet of acrylic and is fashioned into an annular shape with an outer diameter of 7″ having holes cut circumferentially thereon, and wherein the annulus pressure plate has a center ring that is 4″ in diameter to mimic the inlet opening diameter of the inverted closet flange.

11. The air horn with an extended pressure chamber of claim 1, wherein the air inlet system includes a ball valve and handle, an air coupler, a threaded male connector, and an air hole drilled into both the walls of the collar coupling and the through pipe of an inverted closet flange.

12. The air horn with an extended pressure chamber of claim 11, wherein the air inlet system is directly connected to a compressed air pump by a hose to allow air flow into said horn, wherein the compressed air pump is capable of storing one gallon to one hundred gallons of compressed air.

13. The air horn with an extended pressure chamber of claim 12, wherein the air inlet system can vary the loudness of said horn from 109 decibels to 129 decibels by adjusting the air flow from the compressed air pump with the ball valve and handle.

14. The air horn with an extended pressure chamber of claim 2, wherein adjusting the height of the pressure relief tube causes tonal changes in the pitch of the horn.

15. The air horn with an extended pressure chamber of claim 1, wherein the optional sound amplification plate is made from a ¼″ thick piece of annular material being either acrylic, aluminum, or steel, and, wherein the optional sound amplification plate is cut and sized to be 7″ in diameter having circumferential holes to accept fastening members to attach said optional sound amplification plate to the air horn's base at the annulus pressure plate, such that the at least ¼″ protruding surface of the extended diaphragm is covered.

16. The air horn with an extended pressure chamber of claim 1, wherein the optional sound amplification plate is made from a ¼″ thick piece of annular material being either acrylic, aluminum, or steel, and, wherein the optional sound amplification plate is cut and sized to be 7″ in diameter and the optional sound amplification plate is not attached to the air horn's base at the annulus pressure plate but is placed on a flat surface for the horn's base to rest, such that the at least ¼″ protruding surface of the extended diaphragm is covered.
